(19) United States
(12) Patent Application Publication
(10) Pub. No.: US 2022/0106982 A1
(43) Pub. Date: Apr. 7, 2022

(54) SLIDING MEMBER

(71) Applicant: TAIHO KOGYO CO., LTD., Toyota-Shi, Aichi (JP)

(72) Inventors: Toru KAWAI, Toyota (JP); Naoki HORIBE, Toyota (JP)

(21) Appl. No.: 17/428,030

(22) PCT Filed: Feb. 5, 2020
(86) PCT No.: PCT/JP2020/004319

§ 371 Date: Aug. 3, 2021

(30) Foreign Application Priority Data
Feb. 6, 2019 (JP) 2019-019802
Feb. 6, 2019 (JP) 2019-019803

(51) Int. Cl. F16C 33/12; F16C 33/14; F16C 33/20; F16C 17/02

(52) U.S. Cl. CPC F16C 33/128; F16C 33/124; F16C 33/145; F16C 2240/60; F16C 17/02; F16C 2240/54; F16C 33/208

(57) ABSTRACT

A sliding member is provided that includes a base having a surface shaped to support a mating member. A metal sintered layer is not exposed on the surface. A resin coating layer is formed on the surface with a thickness greater than 20 μm.

### CROSS REFERENCE TO RELATED APPLICATIONS

This application is a U.S. National Phase Application under 35 U.S.C. 371 of International Application No. PCT/JP2020/004319, filed on Feb. 5, 2020, which claims priority to Japanese Patent Application No. 2019-019802, filed on Feb. 6, 2019 and Japanese Patent Application No. 2019-019803, filed on Feb. 6, 2019. The entire disclosures of the above applications are expressly incorporated by reference herein.

### BACKGROUND

### Technical Field

The present invention relates to a sliding member.

### Related Art

It is known that provision of a resin coating layer on a sliding surface of a sliding member improves characteristics of the sliding surface. For example, U.S. Pat. No. 5,683,571 B discloses a sliding member having a PAI resin as a binder resin and graphite as a solid lubricant.

In the sliding member of U.S. Pat. No. 5,683,571 B, a metal sintered layer is formed on the surface of the underlayer to improve adhesion between the resin coating layer and the underlayer (or back metal). However, in such a sliding member, stress is concentrated on an upper end portion of the metal sintered layer. As a result, a problem arises in that fatigue resistance of the resin coating layer decreases. Use of a thin resin coating layer is known to improve fatigue resistance. However, if the resin coating layer is too thin, a problem arises in that the resin coating layer wears out with use and the underlayer becomes exposed.

The present invention provides a technique that improves both fatigue resistance and wear resistance of a sliding member.

### SUMMARY

According to one aspect of the invention, there is provided a sliding member including a base having a surface shaped to support a mating member, on which surface a metal sintered layer is not exposed; and a resin coating layer formed on the surface and having a thickness greater than 20 μm.

The thickness of the resin coating layer may be greater than 50 μm.

The thickness of the resin coating layer may be 300 μm or less.

The surface roughness of the surface may be 60 μm mRzJIS or less.

The mating member may be a shaft, and the base member may be cylindrically shaped and have an inner peripheral surface for supporting the shaft.

In the inner peripheral surface, the surface roughness in the axial direction of the mating shaft may be greater than the surface roughness in the circumferential direction of the mating shaft.

The fatigue resistance of the resin coating layer may be 50 MPa or more.

The fatigue resistance of the resin coating layer may be 80 MPa or more.

### Effect of the Invention

One aspect of the invention improves fatigue resistance and wear resistance of the sliding member.

### BRIEF DESCRIPTION OF THE DRAWINGS

FIG. 1 illustrates an external appearance of a bushing 1 according to an embodiment.

FIG. 2 illustrates an exemplary cross-sectional structure of a bushing 3.

FIG. 3 illustrates a surface structure of a body 11 and a resin layer 13.

FIG. 4 shows results of a wear test.

### DETAILED DESCRIPTION

### 1. Configuration

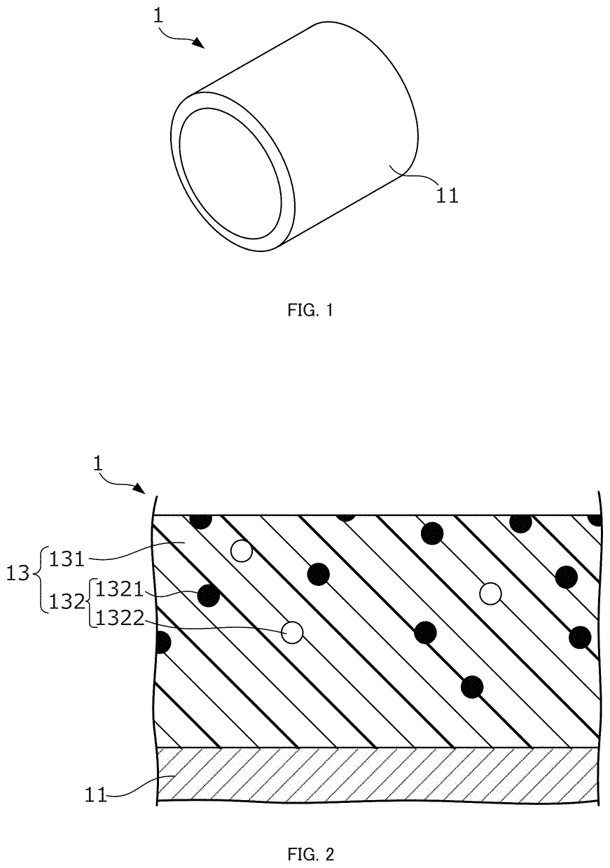

FIG. 1 illustrates a bushing 1 according to one embodiment. The bushing 1 is an example of a sliding member according to the present embodiment. The bushing 1 is used, for example, in a fuel injection pump. The bushing 1 has a body 11. The body 11 is of a cylindrical shape and has an inner peripheral surface for supporting a mating shaft 9 (which is an example of a mating member). To ensure strength and reliability required for the parts, the body 11 is made of a metal (specifically, steel, cast iron, aluminum alloy, or copper alloy, etc.), for example. The body 11 may be formed of a single layer of metal or of multiple metal layers e.g., backing and lining layers.

FIG. 2 illustrates a cross-sectional structure of the bushing 1. FIG. 2 illustrates a cross-section perpendicular to the sliding surface. The bushing 1 has the body 11 (which is an example of a base or a back metal) and a resin layer 13 (which is an example of a resin coating layer). In some types of bushings, a sintered layer formed of a metal (for example, copper or a copper alloy) powder is applied to the surface of a base that serves as a base of a resin layer. However, the bushing 1 according to the present embodiment does not have a sintered layer (the metal sintered layer is not exposed). By omitting a sintered layer, it is possible to reduce stress concentration at the upper end portion of the sintered layer of the resin layer, and thus it is possible to improve fatigue resistance.

Instead of having a sintered layer, the surface of the body 11 on which the resin layer 13 is formed is subjected to a roughening treatment. To relieve stress concentration within the surface shape, the surface roughness of the surface on which the resin layer 13 is formed is, for example, less than or equal to 60 μm RzJIS, preferably less than or equal to 30 μm RzJIS, and more preferably in a range greater than or equal to 5 μm RzJIS and less than or equal to 10 μm RzJIS.

When the mating shaft 9 partially contacts the bushing (in other words, the mating shaft 9 contacts the sliding surface in a state inclined with respect to the sliding surface), the surface roughness in the axial direction of the mating shaft 9 is preferably greater than the surface roughness in the circumferential direction, so as to suppress peeling of the resin layer 13 from the body 11 under shearing stress.

The resin layer 13 is formed of a resin material suitable for a sliding member. The resin material includes a binder resin 131 and an additive 132 dispersed in the binder resin 131. A thermosetting resin, and more specifically, for example, at least one of a polyimide (PI) resin and a polyamideimide (PAI) resin, is used as the binder resin 131. To improve fatigue resistance, use of a PI resin is preferable to a PAI resin. Among PI resins, a PI resin having a high strength (here, “high strength PI resin” refers to a PI resin having a tensile strength greater than or equal to 150 MPa) is preferably used. To improve fatigue resistance, the content of the binder resin in the resin layer 13 is preferably greater than or equal to 80 vol %, more preferably greater than or equal to 83 vol %, still more preferably greater than or equal to 85 vol %, and still more preferably greater than or equal to 90 vol %.

The additive 132 is a substance for improving the characteristics of the resin layer 13, and includes, for example, at least one of a solid lubricant 1321, a hard substance (hard particles) 1322, and a silane coupling agent (a silane coupling agent is not shown in the figures). The solid lubricant 1321 is an additive for reducing the frictional coefficient of the resin layer 13, and includes, for example, at least one of graphite and MoS₂. Since MoS₂ may in some circumstances easily agglomerate in the resin layer, it is preferable to use graphite as the solid lubricant 1321, not MoS₂. When graphite is used as the solid lubricant 1321, the degree of graphitization is preferably high, for example, greater than or equal to 95%, more preferably greater than or equal to 99%, to reduce the friction coefficient. The hard substance 1322 is a material for improving the seizure resistance and wear resistance of the resin layer 13, and includes, for example, at least one of clay, mullite, and talc. The silane coupling agent is a substance for strengthening the bonding between the binder resin 131 and the solid lubricant 1321.

To improve fatigue resistance, the content of the additive is preferably low, for example, less than or equal to 20 vol % in total, more preferably less than or equal to 17 vol %, still more preferably less than or equal to 15 vol %, and still more preferably less than or equal to 10 vol %. To reduce the coefficient of friction, the content of the solid lubricant is preferably high, for example, greater than or equal to 9 vol %. To reduce the total amount of the additive, the content of the solid lubricant is preferably low, for example, less than or equal to 18 vol %. To improve the seizure resistance and the wear resistance, the content of the hard substance is preferably high, for example, greater than or equal to 0.5 vol %. To reduce the total amount of the additive, the content of the solid lubricant is preferably low, for example, less than or equal to 3 vol %. In adding both to add both the solid lubricant and the hard substance, the content of the solid lubricant is preferably greater than or equal to 9 vol % and less than or equal to 17 vol %, more preferably less than or equal to 14 vol %. The content of the hard substance is preferably greater than or equal to 0.5 vol % and less than or equal to 3 vol %. The content of the silane coupling agent is preferably, for example, greater than or equal to 0.1 wt %, and more preferably greater than or equal to 0.2 wt %, based on the binder resin. From a viewpoint of cost reduction, the content of the silane coupling agent is preferably, for example, 5 wt % or less, and more preferably 3 wt % or less relative to the binder resin.

To reduce the surface roughness after the cutting process, it is preferable that the particle diameter of the additive 132 is small. For example, it is preferable that the average particle diameter of the additive 132 is smaller than the average particle diameter of the metal powder used for the sintered layer 12. Further, both the solid lubricant 1321 and the hard substance 1322 preferably have an average particle diameter of less than or equal to 5 μm, and more preferably less than or equal to 3 μm.

Since the resin layer 13 is used for the sliding member, the fatigue resistance strength, that is, the fatigue surface pressure is preferably greater than or equal to 50 MPa, more preferably greater than or equal to 80 MPa, and still more preferably greater than or equal to 90 MPa. The method of measuring the fatigue surface pressure will be described later. To improve the fatigue resistance of the resin layer 13, the average particle diameter of the solid lubricant 1321 used as the material is preferably small, for example, preferably twice or less than the average particle diameter of the hard matter 1322, and more preferably less than the average particle diameter of the hard matter 1322.

The fatigue resistance of the resin layer 13 tends to decrease when the content of the additive 132 increases. In this embodiment, fatigue resistance is improved by suppressing the content of the additive.

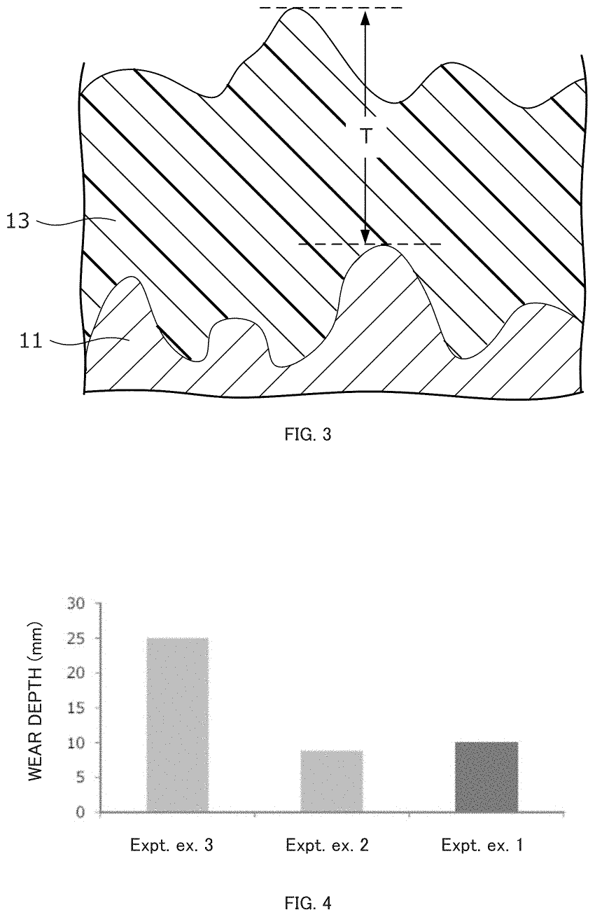

FIG. 3 schematically illustrates a surface structure of the body 11 and the resin layer 13. FIG. 3 illustrates a cross section perpendicular to the sliding surface in the same manner as in FIG. 2. To suppress the resin layer 13 from being worn and exposing the base layer 11 due to the use of the bushing 1, the thickness of the resin layer 13 is preferably greater than 20 μm, more preferably greater than 50 μm, and still more preferably greater than 100 μm. The thickness of the resin layer 13 is preferably 300 μm or less to improve the fatigue resistance and improve the seizure resistance. It is of note that the film thickness T of the resin layer 13, as shown in FIG. 3, from the highest position of the convexities of the body 11 surface, refers to the length to the highest position of the surface of the resin layer 13.

### 2. Experimental Examples

The inventors of the present disclosure produced test pieces of the sliding member under various conditions, and evaluated the characteristics of the resin layer 13 with respect to these test pieces.

### 2-1. Preparation of Test Pieces

A steel plate (of SPCC) having a thickness of 1.5 mm was used as the base. In Experimental Example 1, the substrate surface was roughened by sanding. The surface roughness after roughening was 20 to 60 μmRzJIS. In Experimental Examples 2 and 3, a copper alloy powder having an average particle diameter of 100 μm was sprayed on a base to a thickness of 100 μm, and then sintered by heating to 930° C. in a reducing atmosphere without being depressed. For these test pieces, a precursor solution for forming a resin layer having the composition of Table 1 was prepared, and this precursor solution was applied by a knife coating method on top of the sintered layer. After application, it was dried in the range of room temperature to about 200° C. for about 60 to 90 minutes. Thereafter, the temperature was raised to about 300° C. and baked for about 30 to 90 minutes.

TABLE 1

| | | | Hard | Binder resin | | | silane | |
|---|---|---|---|---|---|---|---|---|
| | Solid lubricant | | substance | High | | | coupling | |
| | Gr. | MoS2 | clay | strength | | | agent | sintered |
| | vol % | vol % | vol % | PI | PI | PAI | wt % | layer |
| Experimental | 15 | — | 2 | 83 | — | — | 1.0 | No |
| Example 1 | | | | | | | | |
| Experimental | 15 | — | 2 | 83 | — | — | 1.0 | |
| Example 2 | | | | | | | | |
| Experimental | 17 | 10 | 3 | — | 35 | 35 | — | |
| Example 3 | | | | | | | | |

In Experimental Examples 1 and 2, graphite having an average particle diameter (d50 on a volume basis) of 1.5 μm and a degree of graphitization of 99% was used. As the high-strength PI resin, a high-strength PI resin having a tensile strength of 195 MPa, an elongation of 90%, an elastic modulus of 3.8 GPa, and a glass-transition temperature Tg of 285° C. was used. In Experimental Example 3, graphite having an average particle diameter of 12.5 μm and a graphitization degree of 90%, and MoS₂ with a mean particle size of 1.5 μm was used. Further, a PI resin having a tensile strength of 119 MPa, an elongation of 47%, and a glass transition temperature Tg of 360° C. was used, and a PAI resin having a tensile strength of 112 MPa, an elongation of 17%, an elastic modulus of 2.7 GPa, and a glass transition temperature Tg of 288° C. was used. In Experimental Examples 1 and 2, as the silane coupling agent, chemical formula 3 (H₃CO)SiC₃H₆—NH—C₃H₆Si(OCH₃)₃ was used. In Table 1, the content of the silane coupling agent is indicated by the weight ratio relative to the high-strength PI resin. In Experimental Examples 1-3, a clay having a structural expression of Al₂O₃.2SiO₂ and a mean particle size of 3 μm was used.

In Experimental Examples 1 and 2, only graphite was used as the solid lubricant (i.e., no other solid lubricant such as MoS₂, etc.) was used as the solid lubricant. Moreover, additives other than the solid lubricant, the hard substance, and the silane coupling agent shown in Table 1 were not included. The additives each had an average particle size of 3 μm or less.

### 2-2. Wear Test

Wear test was performed on the test pieces of Experimental Examples 1 to 3. The wear test was carried out under the following conditions, and the wear depth after the test was recorded.
Tester: Box-type bushing tester
Surface pressure: 1.8 MPa
Test pattern: run & stop (100,000 cycles)
Lubricating oil: Kerosene (at room temperature)

FIG. 4 shows the results of the wear test. Compared to Experimental Example 3, the wear depth was reduced to less than half in Experimental Examples 1 and 2. That is, compared with Experimental Example 3, the wear resistance was improved in Experimental Examples 1 and 2.

### 2-3. Fatigue Test

A fatigue test was performed on the test pieces of Experimental Examples 1 to 3. The fatigue test was carried out under the following conditions, the maximum surface pressure fatigue did not occur in the resin layer (maximum surface pressure of the testing machine is 100 MPa) was the fatigue surface pressure.
Tester: Reciprocating load tester
Rotation speed: 3000 rpm
Number of repeats: 105
Test temperature: 100° C. (lubricating oil supply temperature)
Opposite material: S 45 C
Lubricating oils: Engine Oil

Whereas the fatigue surface pressure of Experimental Example 3 is 20 MPa, the fatigue surface pressure of Experimental Example 1 is more than or equal to 110 MPa, the fatigue surface pressure of Experimental Example 2 was 80 MPa. Compared to Experimental Example 3, in Experimental Examples 1 and 2, the fatigue resistance surface pressure improved. Further, compared with Experimental Example 2, the fatigue resistance surface pressure improved in Experimental Example 1.

### 2-4. Seizure Test

The test pieces of Experimental Example 1 and Experimental Example 2 were subjected to a seizure test. The seizure test was carried out under the following conditions, and when seizure occurred the surface pressure was taken as the seizure surface pressure.
Tester: Static load seizure tester
Load: Step-up 1 kN/5 min
Rotating speed: 6000 rpm
Lubricating oil: paraffin oil

As a result of this test, the seizure surface pressure in Experimental Example 1 was 40 MPa, and the seizure surface pressure in Experimental Example 2 was 32 MPa. As described above, compared with Experimental Example 2, the seizure resistance improved in Experimental Example 1. As regards the state of the sliding surface after the test, the resin layer was damaged, but the back metal was not exposed. That is, even in Experimental Example 1, the resin layer was not peeled off and the back metal was not exposed.

In addition, in Experimental Example 1 and Experimental Example 2, an adhesion force between the main body and the resin layer was tested, and in each an adhesion force equal to or higher than the strength of the adhesive used in the test, and there was no difference in the adhesion force within the range of the test conditions.

### 3. Modification

It is of note that the various materials used in the above examples and their compositions are merely examples, and the present invention is not limited thereto. The resin material according to the present invention may contain unintentional impurities. The bushing 1 is not limited to use in a fuel injection pump, and may be used in various types of bearings, compressors, or the like. The sliding member according to the present invention is not limited to the bushing 1, and the present invention may be applied to other sliding members such as a half bearing or a swash plate.

1. A sliding member comprising:
a base shaped to have a surface that supports a mating member, on which surface a metal sintered layer is not exposed; and
a resin coating layer formed on the surface and having a thickness greater than 20 μm,
wherein a surface roughness of the surface is 60 μmRzJIS or less, and
a fatigue resistance of the resin coating layer is greater than or equal to 50 MPa.

2. The sliding member according to claim 1, wherein
the thickness of the resin coating layer is greater than 50 μm.

3. The sliding member according to claim 1, wherein
the thickness of the resin coating layer is 300 μm or less.

4. (canceled)

5. The sliding member according to claim 1, wherein
the mating member is a shaft, and
the base is cylindrically shaped and has an inner peripheral surface for supporting the shaft.

6. The sliding member according to claim 5, wherein
in the inner peripheral surface, the surface roughness in the axial direction of the shaft is greater than the surface roughness in the circumferential direction of the shaft.

7. (canceled)

8. The sliding member according to claim 1, wherein
the fatigue resistance of the resin coating layer is greater than or equal to 80 MPa.

9. The sliding member according to claim 1, wherein
the thickness of the resin coating layer is greater than 100 μm.
